(19) United States
(12) Patent Application Publication
(10) Pub. No.: US 2010/0245296 A1
(43) Pub. Date: Sep. 30, 2010

(54) PORTABLE ELECTRONIC DEVICE AND PAGE TURNING METHOD THEREOF

(75) Inventors: KIM-YEUNG SIP, Shenzhen City (CN); KUI-JUN WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/494,325

(22) Filed: Jun. 30, 2009

(30) Foreign Application Priority Data
Mar. 25, 2009 (CN) 200910301134.6

(51) Int. Cl. G06F 3/033

(52) U.S. Cl. 345/184

(57) ABSTRACT

A portable electronic device includes a navigation key assembly, a memory unit, a processing unit and a display unit. The navigation key assembly includes a knob. The memory unit is configured to store an electronic file. The processing unit is electrically connected to the navigation key assembly and is configured to store a predetermined rotation angle within which the knob rotates, and to obtain a total page of the electronic file and a rotated angle of the knob, and to determine how many pages jumped to according to the total page, the predetermined rotation angle and the rotated angle of the knob, and to obtain corresponding contents of the page jumped to. The display unit is configured to display the corresponding contents of the page jumped to.

### BACKGROUND

1. Technical Field

The present disclosure relates to electronic devices, and particularly, to a portable electronic device and a page turning method thereof.

2. Description of Related Art

Portable electronic devices, such as cellular phones, portable gaming devices and portable multimedia players, etc., are increasing additional functionalities. One such additional function is an e-book function. The portable electronic device with the e-book function allows people to read electronic documents/texts on the electronic device. The portable electronic device typically has a navigation key to allow people to turn pages of the electronic documents/texts. During the page turning, people depress the navigation key once to turn one page down/up. To turn several pages, people have to depress the navigation key continuously, which may cause hand or finger discomfort.

What is needed, therefore, is a portable electronic device and a page turning method thereof to overcome the above-described problems.

### BRIEF DESCRIPTION OF THE DRAWINGS

FIG. 1 is a schematic view of a portable electronic device including a navigation key assembly, according to an exemplary embodiment.

FIG. 2 is a partially cross-sectional view taken along line II-II of FIG. 1.

FIG. 3 is a disassembled view of the navigation key assembly of the portable electronic device of FIG. 1.

FIG. 4 is a flow chart of a page turning method of a portable electronic device, according to another exemplary embodiment.

### DETAILED DESCRIPTION

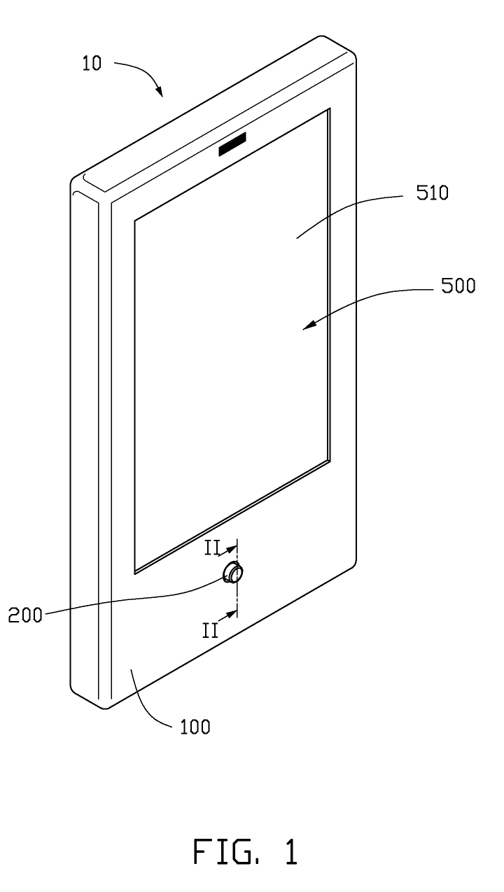

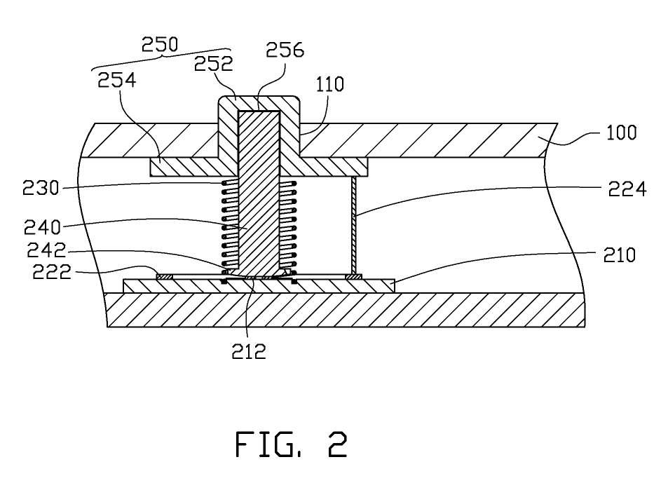

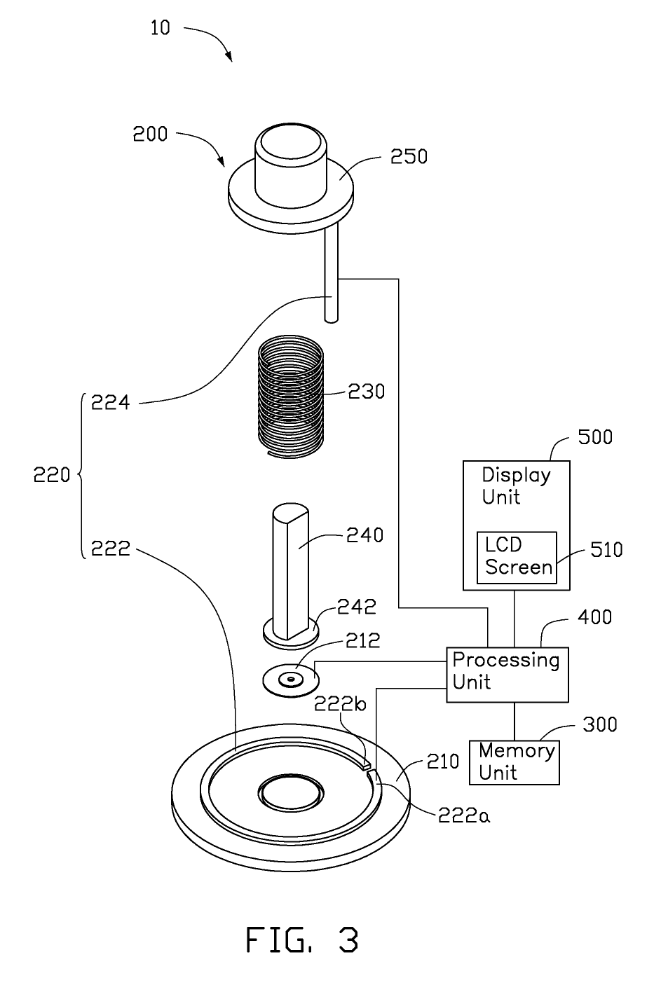

Referring to FIGS. 1 to 3, a portable electronic device 10, according to an exemplary embodiment, includes a front panel 100, a navigation key assembly 200, a memory unit 300, a processing unit 400, and a display unit 500. A through hole 110 is defined in the front panel 100. The memory unit 300 is configured to store an electronic file, such as a text files. The display unit 500 includes a liquid crystal display (LCD) screen 510. In this embodiment, the portable electronic device 10 is a cellular phone. In other embodiment, the portable electronic device 10 may be a multimedia player or a portable gaming device.

The navigation key assembly 200 includes a base plate 210, an adjustable resistor 220, a compression spring 230, a pivot shaft 240, and a knob 250. The base plate 210 includes a central conductive contact 212 formed thereon. The adjustable resistor 220 provides different resistance according to a positioning of the knob 250. The adjustable resistor 220 includes a circular resistor body 222, and an elastic arm 224. The resistor body 222 surrounds/encircles the central conductive contact 212. The gap between two terminals 222a, 222b of the resistor body 222 is rare small and an isolator (not shown) may be filled in the gap. The elastic arm 224 may be a conductive compression spring or be made from other elastic conductive material. A distal end of the elastic arm 224 is electrically connected to the resistor body 222 and the elastic arm 224 is moveable along the resistor body 222. A conductive contact 242 is arranged on an end surface of the pivot shaft 240. The pivot shaft 240 is substantially cylindrical having a flattened cylindrical surface. The pivot shaft 240 extends through the compression spring 230 with the conductive contact 242 aligned with the central conductive contact 212.

The knob 250 is non-rotatably fixed on an end of the pivot shaft 240 away from the conductive contact 242. The knob 250 together with the pivot shaft 240 are rotatable clockwise or counterclockwise about the longitudinal axis of pivot shaft 240. The knob 250 includes a hollow-cylinder operation portion 252 and an outer flange portion 254 extending from the operation portion 252. A pivot hole 256 is defined in the operation portion 252 for non-rotatably receiving the pivot shaft 240 with interference fit. The operation portion 252 protrudes from the front panel 100 through the through hole 110 for operation. A diameter of the outer flange portion 254 is greater than that of the through hole 110 so that the outer flange portion 254 abuts against an inner surface of the front panel 100. The elastic arm 224 is fixed to the outer flange portion 254 and is electrically connected to the resistor body 222. The elastic arm 224 rotates together with the knob 250.

The compression spring 230 abuts between the knob 250 and the base plate 210, therefore compressed between the base plate 210 and the knob 250. When the knob 250 is depressed via the operation portion 252, the conductive contact 242 contacts the central conductive contact 212 to activate the navigation key assembly 200, and the compression spring 230 is further compressed. When the force on the operation portion 252 is removed, the compression spring 230 restores to move the knob 250 and the pivot shaft 240 back to an initial position.

The processing unit 400 is electrically connected to one terminal 222a of the resistor body 222, the elastic arm 224 and the central conductive contact 212. The processing unit 400 is configured to store a predetermined rotation angle within which the knob 250 rotates. The processing unit 400 is configured to obtain a total page of the electronic file and the rotated angle of the knob 250, and to determine how many pages to jump according to the total page number, the predetermined rotation angle and the rotated angle of the knob 250, and to obtain corresponding contents of the page jumped to. Specifically, the predetermined rotation angle is divided by the total page of the electronic file to calculate an angle which the knob 250 needs to rotate at for jumping one page from the current page of the electronic file.

After the activation of the navigation key assembly 200 and the processing unit 400 obtains the total page of the electronic file and, the processing unit 400 is further configured to detect a resistance value between the elastic arm 224 and the terminal 222a of the resistor body 222 to determine which page jumped to from the current page.

Referring to Table 1, an example is shown. In this example, the total page of the electronic file is 20, and the predetermined rotation angle is 360 degrees. Therefore, rotating the knob 250 18 degrees displays a page one page away from the current page, and rotating the knob 250 36 degrees displays a page two pages away from the current page, and so on. When the knob 250 is operated to rotate along the clockwise direction, the processing unit 400 is further configured to control the LCD screen 510 to display how many pages that has been jumped. Thus, the number of page jumped can be known. The processing unit 400 obtains the corresponding contents of the page jumped to in response to the activation of the navigation key assembly 200 and controls the LCD screen 510 to display.

TABLE 1

| Predetermined | | Rotated | Number |
|---|---|---|---|
| Rotation | Total | Angle | of Page |
| Angle (Degree) | Page | (Degree) | Jumped to |
| 360 | 20 | 18 | 1 |
| | | 36 | 2 |
| | | . . . | . . . |
| | | 342 | 19 |
| | | 360 | 20 |

For example, a current page, such a page 1 is jumped to page 11, the knob 250 is operated to rotate 180 degrees along the clockwise direction, and then the knob 250 is depressed to process/enter the rotated input. The processing unit 400 detects the resistance value between the elastic arm 224 and the terminal 222a of the resistor body 222 to determine page 11 jumped to from the page 1, and obtains the corresponding contents of the page 11 and controls the LCD screen 510 to display. In this way, a page turning is easily achieved by the rotation of the knob 250, which comforts the user's hand.

Further, in this embodiment, the LCD screen 510 is a multi-touch screen. The LCD screen 510 is configured to detect user interactions with the LCD screen 510. For example, the LCD screen 510 may detect a radian of a circular touch input to determine a rotated angle of a user finger. The processing unit 400 is further configured to obtain the rotated angle detected by the LCD screen 510, and to determine how many pages jumped to according to the total page, the predetermined rotation angle, the rotated angle of the finger, and the rotated direction of the finger, and to obtain corresponding contents of the page jumped to. If the rotated direction of the finger is the clockwise direction, the processing unit 400 jumps forward from the current page, and obtains the corresponding contents of the page jumped to. If the rotated direction of the finger is the counterclockwise direction, the processing unit 400 jumps backwards from the current page and obtains the corresponding contents of the page jumped to. In this way, another interesting and convenient way to turn pages is achieved.

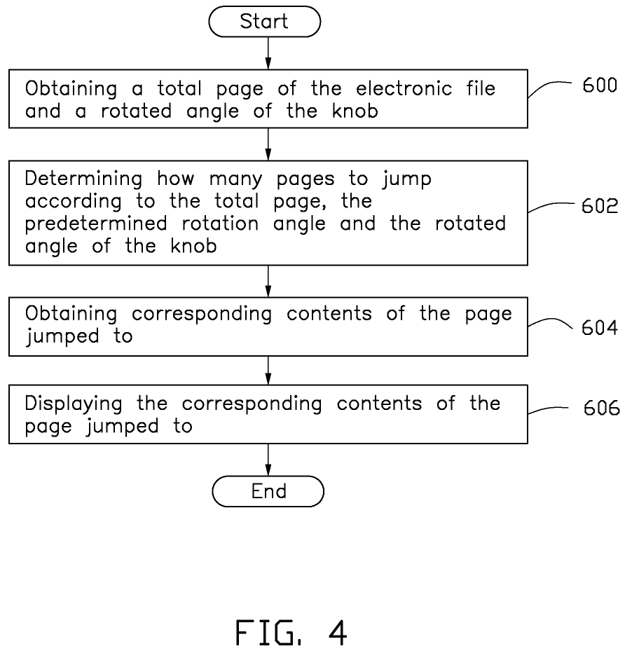

Referring to FIG. 4, a page turning method of the portable electronic device 10 includes step 600 through step 606. Step 600: obtaining a total page of the electronic file and a rotated angle of the knob 250. Step 602: determining how many pages to jump according to the total page, the predetermined rotation angle and the rotated angle of the knob 250. Step 604: obtaining corresponding contents of the page jumped to. Step 606: displaying the corresponding contents of the page jumped to.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A portable electronic device, comprising:
a navigation key assembly comprising a knob;
a memory unit configured to store an electronic file;
a processing unit electrically connected to the navigation key assembly, the processing unit configured to store a predetermined rotation angle within which the knob rotates, and to obtain a total page of the electronic file and a rotated angle of the knob, and to determine how many pages to jump according to the total page, the predetermined rotation angle and the rotated angle of the knob, and to obtain corresponding contents of the page jumped to; and
a display unit configured to display the corresponding contents of the page jumped to.

2. The portable electronic device as claimed in claim 1, wherein the navigation key assembly further comprises an adjustable resistor providing different resistance according to a positioning of the knob; and the processing unit is configured to obtain the rotated angle of the knob according to the resistance of the adjustable resistor.

3. The portable electronic device as claimed in claim 2, wherein the adjustable resistor comprises a circular resistor body and an elastic arm electrically connected to the resistor body, the elastic arm fixed to the knob and rotating together with the knob and moveable along the resistor body and a distal end of the elastic arm electrically connected to the resistor body; and the processing unit is electrically connected to one terminal of the resistor body and the elastic arm to detect a resistance value between the elastic arm and one terminal of the resistor body to determine which page jumped to from a current page.

4. The portable electronic device as claimed in claim 3, wherein the navigation key assembly further comprises a base plate, a pivot shaft fixed to the knob, a compression spring and a conductive contact arranged on an end surface of the pivot shaft, the base plate comprising a central conductive contact formed thereon, the circular resistor body surrounding the central conductive contact, the pivot shaft extending through the compression spring, the central conductive contact aligned with the conductive contact, the compression spring abutting between the knob and the base plate.

5. The portable electronic device as claimed in claim 1, wherein the predetermined rotation angle is 360 degrees.

6. The portable electronic device as claimed in claim 1, wherein the display unit comprises a liquid crystal display screen to display the corresponding contents of the page jumped to.

7. The portable electronic device as claimed in claim 6, wherein the liquid crystal display screen is a multi-touch screen.

8. The portable electronic device as claimed in claim 1, wherein the portable electronic device is a cellular phone.

9. The portable electronic device as claimed in claim 1, wherein the portable electronic device is a multimedia player.

10. The portable electronic device as claimed in claim 1, wherein the portable electronic device is a portable gaming device.

11. A page turning method of a portable electronic device, the portable electronic device comprising a knob and a memory unit configured to store an electronic file, the method comprising:
obtaining a total page of the electronic file and a rotated angle of the knob;
determining how many pages to jump according to the total page, the predetermined rotation angle and the rotated angle of the knob;
obtaining corresponding contents of the page jumped to; and
displaying the corresponding contents of the page jumped to.

12. The method as claimed in claim 11, wherein the predetermined rotation angle is 360 degrees.
